(19) United States
(12) Patent Application Publication
(10) Pub. No.: US 2006/0115068 A1
(43) Pub. Date: Jun. 1, 2006

(54) Virtual service switching function

(75) Inventors: Eran Dotan, Tel Aviv (IL); Ofer Salomon, Kfar Hanagid (IL); Ronny Aruch, Petah-Tikva (IL); Shmuel Betsalel, Kiryat Gat (IL)

Correspondence Address: WELSH & KATZ, LTD, 120 S RIVERSIDE PLAZA, 22ND FLOOR, CHICAGO, IL, 60606, US

(73) Assignee: SMART-SS7 LTD., Lod (IL)

(21) Appl. No.: 10/999,407

(22) Filed: Nov. 30, 2004

(51) Int. Cl. H04M 7/00; H04L 12/66

(52) U.S. Cl. 379/221.15; 379/221.08; 370/352

(57) ABSTRACT

A method for providing a virtual service switching function includes receiving a first message from a switch in a telephone network indicative of initiation of a call, the first message including a service parameter that is applicable to the call. Responsively to the service parameter, first and second service control points (SCPs) are invoked to provide respective first and second services in relation to the call. A second message is sent to the switch, in response to the first message, instructing the switch to carry out the call using at least one of the first and second services.

### FIELD OF THE INVENTION

The present invention relates generally to Intelligent Networks, and specifically to devices and methods for carrying out service switching functions associated with Intelligent Network services.

### BACKGROUND OF THE INVENTION

The Intelligent Network (IN) is an architectural concept that enables real-time execution of network services and customer applications in a distributed environment of interconnected computers and switching systems, such as wireline and wireless telephone networks. IN standards have been promulgated by the International Telecommunications Union (ITU-T) and by the American National Standards Institute (ANSI). A useful summary of IN concepts and standards is provided by Faynberg et al., in “The Development of the Wireless Intelligent Network (WIN) and Its Relation to the International Intelligent Network Standards,” Bell Labs Technical Journal (Summer, 1997), pp. 57-80, which is incorporated herein by reference.

In order to provide IN services, network switches are programmed with a call control function (CCF) and a service switching function (SSF), as dictated by IN standards. The CCF provides basic switching capabilities, including the means to establish, manipulate and release calls and connections. When the CCF detects signaling passing through the switch that is related to an IN service, it suspends the call temporarily and passes a trigger to the SSF. Based on the trigger, the SSF passes control of the call to a service control point (SCP). Communications between the SSF and the SCP are based on a standard IN Application Protocol (INAP). The selected SCP processes the call, and then sends instructions back via INAP to the SSF as to how the call should be handled by the CCF. The unified IN architecture allows different service providers to create SCPs that implement their own particular services, independent of the underlying network technology.

While the CCF and SSF are implemented in the network switches themselves, the SCP is typically a separate element, which communicates with the network switches over the telephone network. Multiple SCPs may communicate with a given switch, and the SSF of the switch is programmed to choose the SCP for each call depending on the trigger parameters. These parameters include the originating IN category key (OICK), corresponding to the number of the telephone from which the call originates, and the terminating IN category key (TICK), corresponding to the destination telephone number. Typically, the OICK and TICK for each telephone number are stored in a table, such as the home location register (HLR) in cellular networks.

Various methods and systems have been proposed for enhancing the functionality and versatility of IN components. For example, U.S. Patent Application Publication 2003/0165135, whose disclosure is incorporated herein by reference, describes a flexible service gateway, separate from network switching equipment, which acts as a service switching point (SSP) for IN services. The gateway captures network signaling messages and assumes the service switching function (SSF) that is programmed into the switching equipment itself in conventional IN architecture. By separating IN functionality from network switching equipment, the SSP gateway is said to enable upgraded IN capabilities, platforms and services to be provided simply and economically, without the need to replace or reprogram the switching equipment itself. The gateway is designed to support multiple network types and different application platforms simultaneously.

As another example, PCT Patent Application Publication WO 98/28885, whose disclosure is incorporated herein by reference, describes an Internet-SS7 gateway. The gateway connects to the Internet and to a node in an intelligent network and is provided with means for converting a signal from the node in the intelligent network into a compatible signal for the Internet, and vice versa. It provides a method for connecting an information server via the Internet to a node in an intelligent network.

### SUMMARY OF THE INVENTION

Although the IN architecture permits a wide variety of different services to be offered by deployment of appropriate SCPs, IN systems still have inherent limitations in terms of the mix of services and options that a given subscriber may receive. As a specific example, only a single OICK and TICK can be defined in the HLR for each telephone number. Therefore, the SSF of the network switch that controls a given call can select only a single, fixed SCP for each originating or terminating telephone number. Consequently, the telephone network operator can generally offer no more than a single IN service type for calls that originate from or are directed to any given number.

Embodiments of the present invention address and overcome these limitations by providing a “virtual SSF” device (VSSF), which communicates simultaneously with network switches and with multiple SCPs, and thus permits multiple IN services to be provided in a single call. On the telephone network side, the VSSF emulates a SCP, and thus communicates with the actual SSF of network switches using standard INAP and Signaling System 7 (SS7) messages. The VSSF can therefore be integrated into standard telephone networks without modification to the existing infrastructure. Optionally, the VSSF may be configured to communicate with other communication networks, as well, such as Internet Protocol (IP) packet networks, so that IN services can also be provided via the packet network.

On the service side, in communicating with the SCPs, the VSSF emulates SSF operation of conventional IN switches. Therefore, existing SCPs can communicate with the VSSF using standard protocols and messaging, as though they were communicating with an IN switch. Optionally, the VSSF is configured to support multiple, different IN protocols for communicating with different types of SCPs. For each call received from the telephone network (or other network), application logic in the VSSF tracks the state of the call and invokes the services of each appropriate SCP as required. Consequently, for any given service key that it receives from the network for a particular call, the VSSF can apply the services of multiple SCPs in substantially any logical combination or sequence. The telephone network operator is thus able to offer subscribers a large variety of service packages to choose from, by “mix and match” among the capabilities of existing SCPs, simply by defining new service keys on the VSSF. There is no need to deploy or reprogram a SCP for each new package as in IN systems known in the art.

Although embodiments of the present invention are described hereinbelow with reference particular to elements of cellular telephone networks, the principles of the present invention are similarly applicable in telephone networks of other types, such as public switched telephone networks (PSTN).

There is therefore provided, in accordance with an embodiment of the present invention, a method for providing a virtual service switching function, including:

receiving a first message from a switch in a telephone network indicative of initiation of a call, the first message comprising a service parameter that is applicable to the call;

responsively to the service parameter, invoking first and second service control points (SCPs) to provide respective first and second services in relation to the call; and

sending a second message to the switch, in response to the first message, instructing the switch to carry out the call using at least one of the first and second services.

Typically, receiving the first message includes receiving an Intelligent Network Application Protocol (INAP) message from a service switching function of the switch. The telephone network may include a cellular communication network.

In some embodiments, the method includes receiving a third message sent from a packet network using a packet network protocol, and invoking at least one of the first and second SCPs responsively to the third message in order to provide one or more of the first and second services to a user of the packet network. Typically, receiving the third message includes receiving the third message in relation to a Voice over Internet Protocol (VoIP) call placed by the user over the packet network or, alternatively, in relation to a data service requested by the user of the packet network. Additionally or alternatively, the first service includes a prepayment service, and the user has a prepaid account with the prepayment service, and invoking the at least one of the first and second SCPs includes causing the first SCP to charge the prepaid account in connection with use of the packet network. Further additionally or alternatively, receiving the third message includes receiving a request to provide the one or more of the first and second services to the user at a specified telephone number via the telephone network. In disclosed embodiment, receiving the third message includes receiving at least one of a Session Initiation Protocol (SIP) message, a Transport Control Protocol (TCP) message, a Structured Query Language (SQL) message, and a Hypertext Transfer Protocol (HTTP) message.

Typically, obtaining the service parameter includes a service key, which is determined by at least one of an originating IN category key (OICK) corresponding to an originating telephone number of the call, and a terminating IN category key (TICK) corresponding to a terminating telephone number of the call, which are stored in a home location register (HLR) of the telephone network. The method may include defining, for use in the HLR, a first category key corresponding to the first service, a second category key corresponding to the second service, and a third category key corresponding to a combination of the first and second services.

Typically, invoking the first and second SCPs includes sending an Intelligent Network Application Protocol (INAP) message to at least one of the first and second SCPs. In disclosed embodiments, sending the INAP message includes sending the INAP message from a virtual service switching function device while emulating a service switching function (SSF) of the switch, and sending the second message to the switch includes sending the second message from the virtual service switching function device while emulating a service control function of the at least one of the first and second SCPs.

In one embodiment, the second SCP is included in a virtual service switching function device, and invoking the first and second SCPs includes sending a message from the VSSF device to the first SCP.

In disclosed embodiments, receiving the first message includes receiving the first message at a virtual service switching function device while emulating a service control function of the at least one of the first and second SCPs, and sending the second message includes conveying an instruction from the virtual service switching function device to the at least one of the first and second SCPs to send the second message through the telephone network to the switch. In one embodiment, conveying the instruction includes making a determination that the second service will not be required for the call, and conveying the instruction to the first SCP responsively to the determination.

In one embodiment, invoking the first and second SCPs includes sending a customized applications for mobile network enhanced logic (CAMEL) protocol message to at least one of the first and second SCPs. In another embodiment, invoking the first and second SCPs includes communicating with the first and second SCPs using different, respective first and second communication protocols.

In disclosed embodiments, the first and second services are selected from a group of services consisting of a prepayment service, a personal number (PN) service, a call transfer service, a virtual private network service, a waking service, and a charge reversal service.

In one of these embodiments, the first service is the PN service, and the second service is the call transfer service, and sending the second message includes instructing the switch, using the PN service, to cause first and second telephones to ring, whereupon a user accepts the call on the first telephone, and the method includes receiving a signal from the first telephone to transfer the call to the second telephone, and instructing the switch, using the call transfer service, to transfer the call to the second telephone.

In another embodiment, the first service is the charge reversal service, and the second service is the prepayment service, and invoking the first and second SCPs includes evaluating a terminating telephone number of the call against a predetermined list, using the first SCP, in order to determine whether to apply the charge reversal service, and if the terminating telephone number does not appear on the list, charging a prepaid account for the call using the second SCP.

There is also provided, in accordance with an embodiment of the present invention, apparatus for providing a virtual service switching function, including:

a network interface, which is coupled to receive a first message from a switch in a telephone network indicative of initiation of a call, the first message including a service parameter that is applicable to the call;

a service interface, which is coupled to communicate with first and second service control points (SCPs), which are configured to provide respective first and second services; and

application logic, which is adapted, responsively to the service parameter, to invoke the first and second SCPs via the service interface responsively to the service key, and to send a second message to the switch via the network interface, in response to the first message, instructing the switch to carry out the call using at least one of the first and second services.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a virtual SSF device (VSSF) in communication with circuit- and packet-switched networks, in accordance with an embodiment of the present invention;

FIG. 2 is a block diagram that schematically shows a VSSF in communication with other network components, in accordance with an embodiment of the present invention;

FIG. 3 is a block diagram that schematically shows functional details of a VSSF, in accordance with an embodiment of the present invention;

FIG. 4 is a block diagram that schematically illustrates provision of network services using a VSSF, in accordance with an embodiment of the present invention;

FIG. 5 is a block diagram that schematically illustrates provision of network services using a VSSF, in accordance with another embodiment of the present invention; and

FIG. 6 is a block diagram that schematically illustrates provision of network services using a VSSF, in accordance with yet another embodiment of the present invention.

### DETAILED DESCRIPTION OF EMBODIMENTS

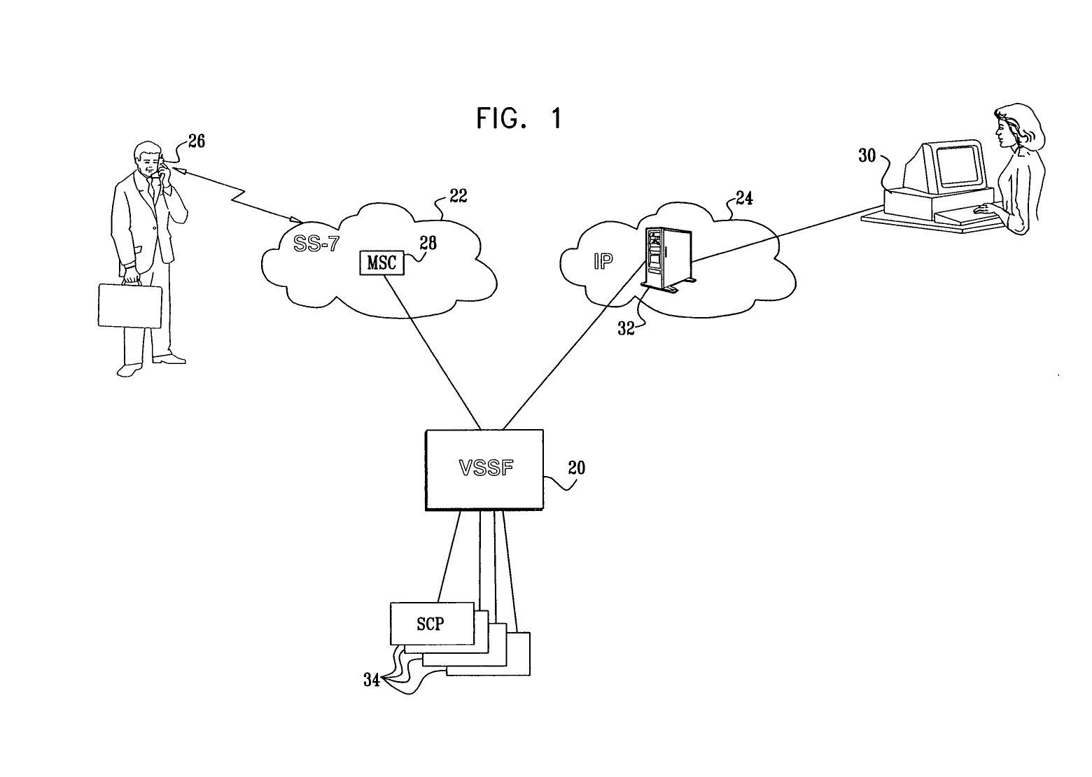

FIG. 1 is a block diagram that schematically illustrates a virtual SSF device (VSSF) 20, in communication with a circuit-switch network 22 and a packet-switched network 24, in accordance with an embodiment of the present invention. Network 22 typically operates in accordance with the SS7 protocol family, and provides IN functionality using the VSSF and service control points (SCPs) 34. In the example shown in the figure, network 22 comprises a cellular public land mobile network (PLMN), but VSSF 20 may similarly serve other types of SS7 networks, such as the public switched telephone network (PSTN). Network 22 comprises one or more switches, such as a mobile switching center (MSC) 28 shown in FIG. 1. Although only a single switch is shown here for the sake of simplicity, in practice VSSF 20 may communicate with multiple different network switches. Furthermore, although the exemplary embodiments described hereinbelow relate to MSC 28, the functions attributed to the MSC in these embodiments may similarly be carried out by IN-enabled switches of other types.

When MSC 28 receives a call from a telephone 26 and determines that an IN service should be applied to the call, it suspends the call temporarily and passes control of the call to VSSF 20. The MSC and the VSSF communicate using standard INAP and SS7 signaling, as though the VSSF were a conventional SCP. Depending on the service parameters conveyed by the MSC, the VSSF invokes one or more of SCPs 34 in order to process the call. Typically, the service parameters conveyed by the MSC comprise a service key, which is determined by the MSC based on the originating and/or terminating telephone number. Details of the interaction between the VSSF and SCPs and a number of exemplary call handling scenarios are described hereinbelow. Based on the interaction with the appropriate SCPs, the VSSF sends instructions back via INAP to MSC 28 as to how the call should be handled. Alternatively, in some scenarios, the VSSF may pass instructions transparently between the MSC and one of the SCPs or may instruct the SCP to communicate with the MSC directly.

Optionally, VSSF 20 is also configured to communicate with other networks, such as packet-switched network 24. Typically, network 24 comprises an Internet Protocol (IP) network, and the VSSF is configured to communicate with entities in network 24, such as a server 32, using an appropriate packet communication protocol. Server 32 may comprise, for example, a Web server, a database server or a “soft switch” serving Voice over IP (VoIP) audio communications. Upon receiving a request from a subscriber computer 30 for a type of data or voice service that is supported by the VSSF, server 32 passes the request to the VSSF, which then invokes the appropriate SCPs to determine how to handle the request.

In this manner, VSSF 20 can act as a service gateway, permitting packet network users to access SCP services that were designed for voice communications in the SS7 network. The protocol handling functions of the VSSF, as described below, solve the problems of compatibility between packet networks and SCP-based IN services, and thus permit packet network operators to offer a package of IN services. Even when protocols are updated (as occurs particularly in IP networks), only the protocol handling part of VSSF 20 need be changed in order to maintain compatibility. The gateway function of the VSSF is particularly useful in integrating VoIP with circuit-switched telephone networks. It can also be used to charge the user's prepaid telephone account for content delivered via packet network 24.

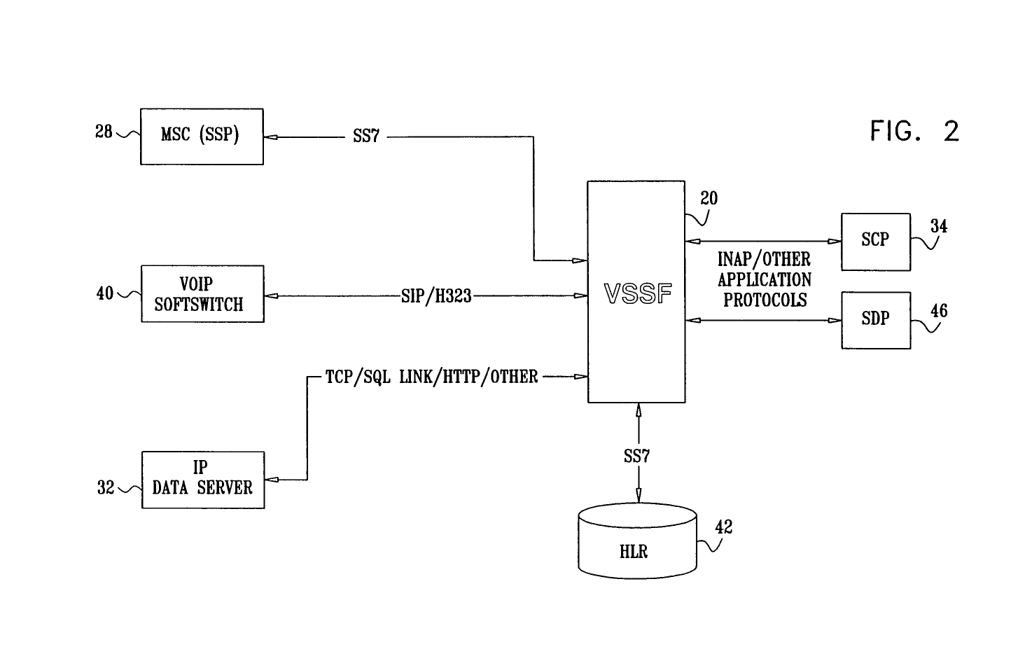

FIG. 2 is a block diagram that schematically shows details of communications between VSSF 20 and other network and service components, in accordance with an embodiment of the present invention. VSSF 20 has multiple protocol capabilities, on both the network side and the service side. On the network side, VSSF 20 communicates with service switching points (SSPs), such as MSC 28, in telephone network 22 using SS7 protocols, so that the VSSF appears to the SSP as though it were a conventional SCP. The VSSF communicates with entities, such as server 32, in packet network 24 using packet communication protocols, as appropriate to the types of applications that the VSSF is called upon to handle. Typically, VSSF 20 receives and transmits TCP/IP or UDP/IP packets to and from switch 32. These packets may carry messages based on higher-level protocols depending on the application in question. For example, HTTP may be used for Web protocols, while SQL-Link might be used for database applications. For packet voice applications, such as VoIP, the VSSF may communicate with a soft switch 40 using H.323 or SIP.

On the service side, VSSF 20 communicates with IN SCPs 34 using INAP, so that it appears to the SCPs as though the VSSF were an actual network SSP. The term “SCP” is used broadly in the context of the present patent application and in the claims to include any and all types of servers that may be used to provide IN services. Thus, in FIG. 2, a service data point (SDP) 46 should also be regarded as a SCP in this context. The SDP is typically used in providing a service data function (SDF) to a SCP in certain types of IN services, such as prepaid calling services. Typically, VSSF 20 has INAP interfaces that are compatible with a range of different INAP versions, including the Capabilities Set 1 (CS1) and Capabilities Set 2 (CS2) versions and their variants that are used by different SCP and switch vendors, as well as with non-INAP application protocols. For example, the VSSF may have an interface that uses CAMEL (customized applications for mobile network enhanced logic), as defined in the applicable GSM standard. The CAMEL server in this case should also be regarded as a SCP.

VSSF 20 also has interfaces to databases used in networks 22 and 24, such as a HLR 42. The VSSF may consult the HLR in order to read service parameters, such as the location of the subscriber for the originating and/or terminating telephone numbers of calls referred to it by MSC 28.

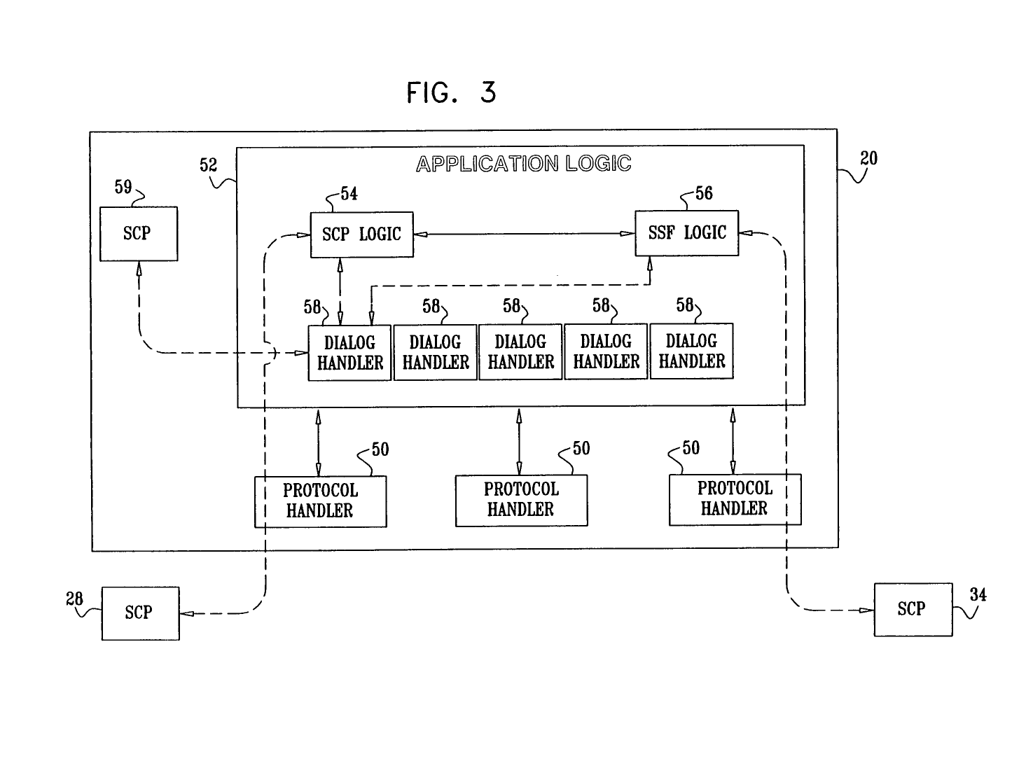

FIG. 3 is a block diagram that schematically shows functional details of VSSF 20, in accordance with an embodiment of the present invention. The functional blocks shown in FIG. 3 do not necessarily correspond to physical components of the VSSF. Typically, the VSSF comprises a set of processor cards and interface cards, connected in a suitable rack, which perform the functions illustrated in the figure. Some of the functions that are shown as single blocks in FIG. 3 may be spread over multiple cards, while in other cases, the functions of multiple blocks may be performed by a single card or processor. Appropriate choices of cards, processors and interconnections for performing the functions shown in FIG. 3 will be apparent to those skilled in the art based upon the description that follows.

The functions of the network-side interface (to MSC 28) and the service-side interface (to SCP 34) in VSSF 20 are carried out by protocol handlers 50. Each protocol handler is programmed to receive messages in a particular protocol, such as INAP, IP or one of the other network or application protocols described above, and to convey the information carried by the messages to application logic 52 of the VSSF. By the same token, the protocol handlers receive information from the application logic and send messages in the corresponding protocols to the appropriate network or service components. Methods for translating different network and service protocols into a standard, unified format for purposes of application processing and control are described, for example, in the above-mentioned U.S. Patent Application Publication 2003/0165135. Protocol handlers 50 may thus be defined not only for INAP, but also for other service protocols, such as CAMEL, and various packet protocols, such as those enumerated above. The modularity of protocol handlers 50 permits VSSF 20 to be configured easily to support new protocols, simply by adding appropriate protocol handlers.

Application logic 52 comprises SCP logic 54, for handling functions that are associated with network-side components (such as MSC 28), and SSF logic 56, for functions associated with service side components (such as SCP 34). SCP logic 54 emulates the operation of a conventional SCP, so that MSC 28 can interact with VSSF 20 as it would with any other SCP. SSF logic 56 emulates the SSF operation of conventional IN switches, so that SCP 34 interacts with VSSF 20 as it would with a network SSP. In addition, for purposes of communicating with HLR 42, SSF logic 56 emulates a standard gateway mobile switching center (GMSC). Thus, no changes are required in existing network components or SCPs in order to integrate them with VSSF 20.

For each call handled by VSSF 20, application logic 52 opens a session of a dialog handler 58. The dialog handler tracks the state of the call based on events generated by SCP logic 54 and SSF logic 56, and passes appropriate instructions to these elements in order to carry out the required message flow. The events may include, for example, basic call state model (BCSM) events, as well as charging events and other association and reporting events. Application logic 52 determines which SCP 34 or combination of SCPs to invoke for each event in each particular call depending on the service key and other parameters received from MSC 28 (or from other network-side components) and on the current session state. For example, for a given service key received from MSC 28, the application logic may determine that a certain combination of SCPs is to be invoked, in accordance with a certain logic flow, as programmed in advance by a system operator. Exemplary scenarios of this sort, involving multiple SCPs in a single call, are described hereinbelow.

Optionally, VSSF 20 also comprises a built-in SCP 59, which performs certain SCP functions internally, in place of invoking an external SCP. Thus, in addition to (or instead of) integrating services provided by different external SCPs 34, the VSSF may integrate services of internal SCP 59 with those of the external SCPs. Providing some SCP functions internally in this manner reduces the amount of INAP traffic on network 22 and can also reduce the need for memory resources among VSSF 20 and SCPs 34. In the context of the present patent application and in the claims, the term SCP refers generally to both “external” and “internal” SCPs (as defined in this paragraph), unless explicitly noted otherwise. The SCP functions described in this patent application with reference to external SCPs may likewise be performed by an internal SCP, and vice versa.

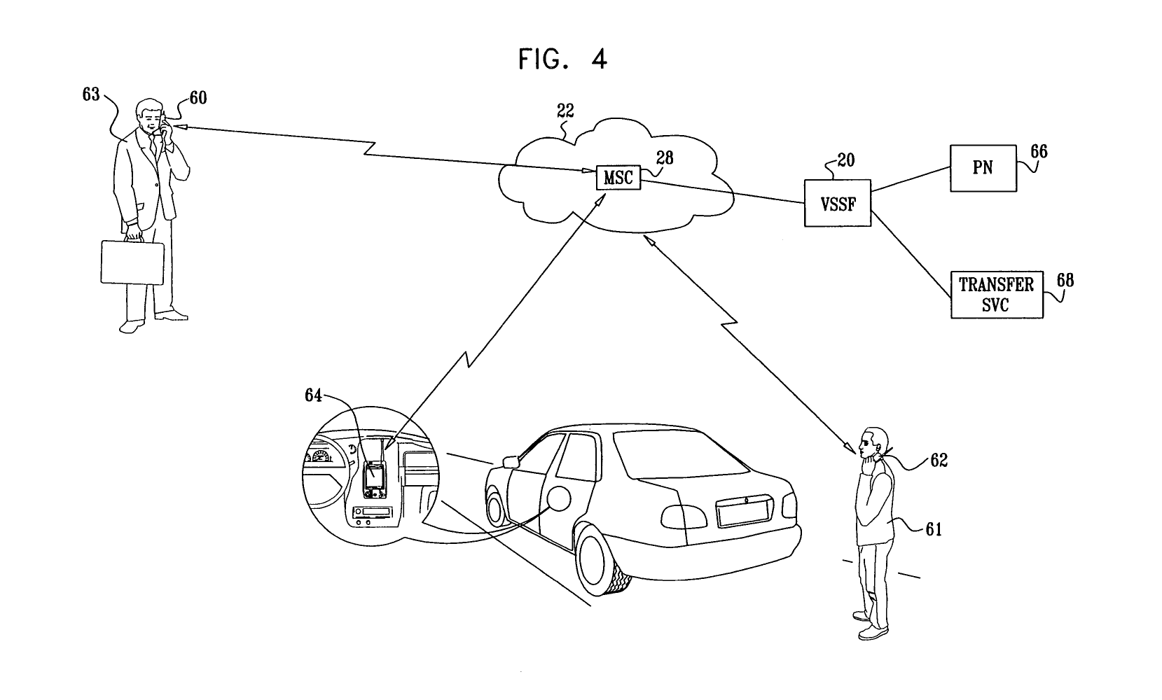

FIG. 4 is a block diagram that schematically illustrates provision of network services using VSSF 20, in accordance with an embodiment of the present invention. In this example, a cellular telephone user 61 subscribes to a “Personal Number” (PN) service. This service provides that when another user 63 dials the telephone number of user 61, two telephones will ring, in this case, a portable telephone 62 and a car telephone 64. When user 61 picks up one of the two telephones, the other one stops ringing, as well. This sort of service is currently offered by cellular network operators who have deployed an appropriate PN SCP 66.

The operator of network 22 also offers a “virtual PBX” service, which permits subscribers to transfer calls among a predefined set of numbers, as in a conventional, wired PBX. This service is supported by a transfer service SCP 68. By virtue of the use of VSSF 20, the network operator is able to offer users a combined PN/call transfer service, in addition to the separate PN and call transfer services that are individually supported by SCPs 66 and 68. This service permits user 61, for example, to receive a call on telephone 62 when he is out of his car, and then to transfer the call to car telephone 64 when he gets into the car to begin driving.

The network operator exploits VSSF 20 to offer the combined PN/call transfer service without modifying either of SCPs 66 and 68, which are typically supplied as closed software packages by the SCP vendors. For this purpose, the network operator defines a new TICK for the new combined service. This TICK will then appear in HLR 42 as part of the record for telephone numbers, such as the numbers of telephones 62 and 64, that subscribe to the combined service. (As noted above, IN conventions permit only a single OICK and TICK to be recorded in the HLR for each telephone number.) Thus, for example, subscribers to the PN service only will have one TICK value, subscribers to the call transfer service will have another TICK value, and subscribers to the combined service will have a third TICK value. Upon initiation of a call to user 61, MSC 28 looks up the TICK value in HLR 42, and then passes the corresponding service key to VSSF 20. The network operator programs application logic 52 in the VSSF to recognize the service key of each type of service, and to invoke the appropriate SCP in each case. When the terminating telephone number of the call placed by telephone 60 has the TICK value corresponding to the combined service, the corresponding service key causes application logic 52 to invoke both of SCPs 66 and 68 as appropriate to service the call.

Operation of the combined service illustrated in FIG. 4 is initiated when user 63 places a call on telephone 60 by dialing the telephone number of user 61. MSC 28 looks up the number in HLR 42, recognizes it as a target for IN services, and reads the corresponding TICK. The MSC then passes control of the call to VSSF 20 along with the corresponding service key. Based on the service key, SSF logic 56 determines that user 61 subscribes to the combined PN/call transfer service. (The MSC typically also looks up the OICK of telephone 60, and may also determine the service key to pass to VSSF 20 on the basis of the OICK. Exemplary scenarios involving OICK-based services, including services combining multiple SCPs, are described below.) SSF logic 56 then sends an INAP message to PN SCP 66, requesting the actual telephone numbers of telephones 62 and 64. SCP 66 treats this message as though it came from a switch in network 22, and thus returns a suitable INAP message to VSSF 20 indicating the desired telephone numbers.

SCP logic 54 now passes these numbers on to MSC 28, with instructions to ring both of telephones 62 and 64. When user 61 picks up one of the telephones (telephone 62 in this example), the MSC receives the off-hook signal and instructs both telephones to stop ringing. The call now proceeds between telephones 60 and 62. Meanwhile, the state of the call is maintained by one of dialog handlers 58 that has been assigned to the call.

At some point during the call, user 61 decides to transfer the call to telephone 64 (in order to continue speaking while driving, for example). The user signals the transfer by entering a predetermined keystroke or set of keystrokes on the keypad of telephone 62. MSC 28 receives these keystrokes and, in response, passes control of the call back to VSSF 20. For example, the MSC may send a mid-call event to the VSSF, as specified by INAP. Application logic 52 recognizes this mid-call event as a signal to invoke the transfer service of SCP 68. SSF logic 56 therefore sends an INAP message to SCP 68, requesting the telephone number to which the call is to be transferred. (Although in the present example, telephone 64 to which the call is to be transferred is also one of the telephones that participated in the PN service, the transfer may also be to a different telephone that is included in the virtual PBX service of user 61.) SCP 68 informs VSSF 20 of the actual telephone number of telephone 64, and SCP logic 54 accordingly instructs MSC 28 to disconnect the terminating leg of the call from telephone 62 and connect it to telephone 64. The call then continues normally until terminated by one of the users.

Other TICK-based services may be integrated in a similar fashion. For example, the PN service described above may be combined with a “funtone” service, in which the caller hears music, rather than the normal ring tone, while waiting for the called party to pick up. As another example, the various IN services described herein may be combined with virtual private network (VPN) services that are offered on many telephone networks.

Although the exemplary scenario shown in FIG. 4 involves only two different services and SCPs in a single session, in practice the network operator may program application logic 52 to combine three or more different services and SCPs in handling any given call. Each different combination of this sort receives its own OICK and/or TICK value, which causes the MSC to send the appropriate service key for each call, and thus permits application logic 52 to determine which SCPs to invoke in each case. Since all service integration is performed by VSSF 20, the existing SCPs and the service logic used by each individual SCP remain the same, regardless of the different service packages in which the individual SCPs are used. Similarly, although new OICK and TICK values may be added to HLR 42, the structure of the existing HLR is also unchanged, and the network operator need not set up any new network databases to support the multi-service capability of the VSSF.

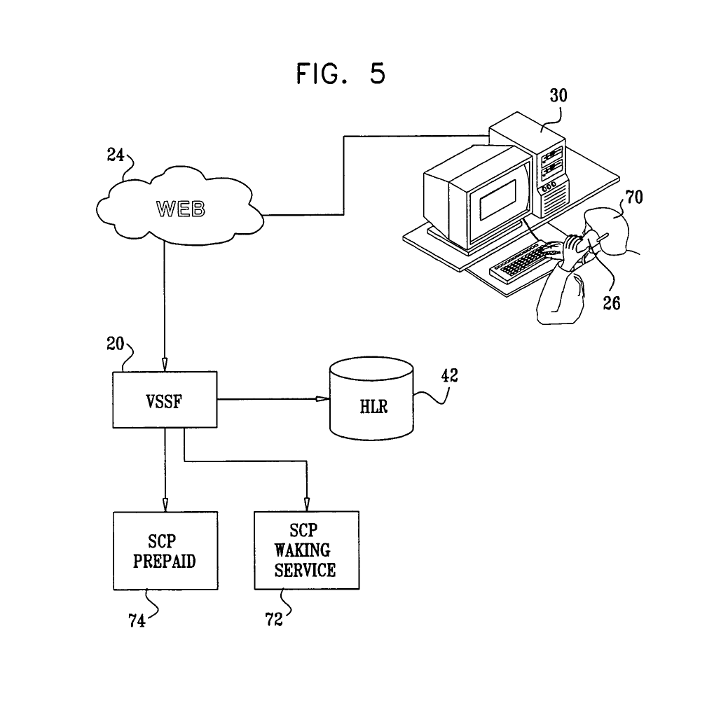

FIG. 5 is a block diagram that schematically illustrates another scenario in which VSSF 20 is used to provide a new combination of services, in accordance with an embodiment of the present invention. This scenario also illustrates how the interface between VSSF 20 and packet network 24 can be used to enhance the functionality of IN services on the telephone network. A user 70 of telephone 26 is assumed to be a prepaid subscriber on telephone network 22. Prepaid calls are handled by a prepayment SCP 74, which records the charges and account balance in the user's telephone account.

In this example, user 70 requests a wake-up call on telephone 26 by accessing the Web site of the telephone network operator using computer 30. VSSF 20 receives the request from network 24 and interrogates HLR 42 to look up service parameters of user 70. In this case, the HLR indicates that user 70 is a prepaid customer. Therefore, before taking further action, VSSF 20 checks with prepayment SCP 74 to ensure that the user has a sufficient balance to pay for the wake-up call. The VSSF may also read the current location of the user from the HLR, in order to know the correct time at which the wake-up call should be placed. The VSSF then invokes a waking service SCP 72 in order to place the wake-up call at the appropriate time.

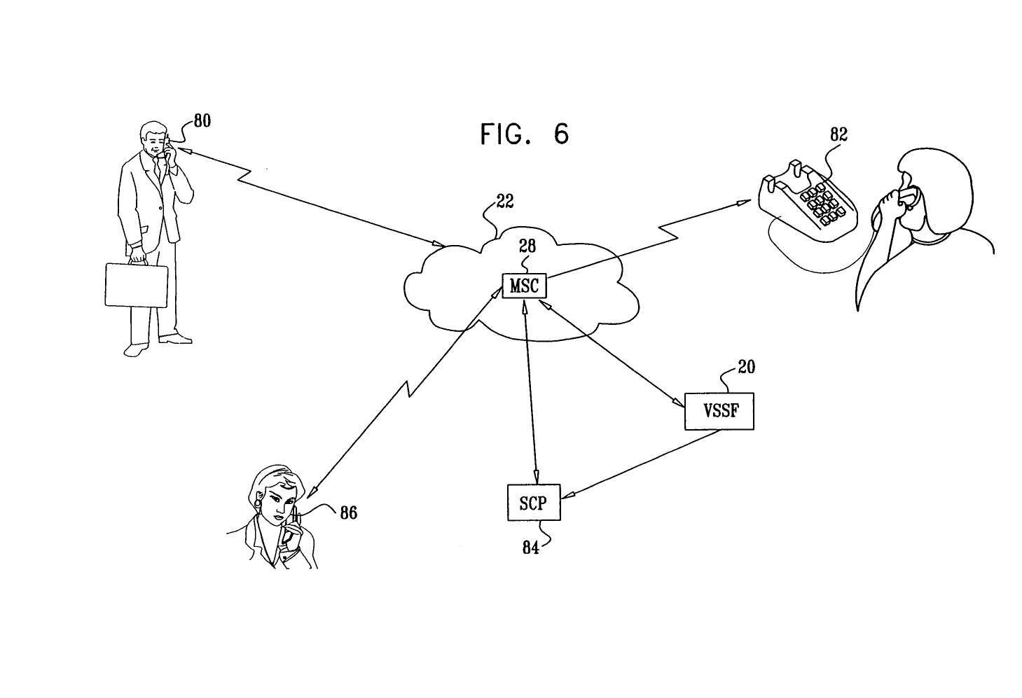

FIG. 6 is a block diagram that schematically illustrates another service scenario involving VSSF 20, in accordance with an embodiment of the present invention. In this scenario, application logic 52 (FIG. 3) in VSSF 20 considers not only the service key provided by MSC 28 based on the OICK of a telephone 80 originating a call, but also the telephone number of a telephone 86 receiving the call. Telephone 80 is configured for prepaid service, which is handled by a prepayment SCP 84. Internal SCP 59 in VSSF 20 (or alternatively, another, external SCP) is configured for an automatic charge reversal (collect dialing) service. In other words, when the user of telephone 80 dials the number of a certain telephone 82, which appears on a predetermined list, the call is automatically charged to the receiving number. This service can be used, for example, to permit a child to call his parents without affecting his allowance of prepaid time. According to the OICK of telephone 80, this user subscribes to both the prepaid and automatic charge reversal services.

Thus, in the example shown in FIG. 6, the user of telephone 80 places a call to telephone 86, which is not on the charge reversal list. MSC 28 reads the OICK of telephone 80 from HLR 42 (FIG. 2), and then transfers control of the call to VSSF 20 with the appropriate service key, which causes the VSSF to invoke internal SCP 59. SCP 59 checks the destination telephone number, and upon determining that the number is not on the list for reversal of charges, returns control of the call to application logic 52. SSF logic 56 then transfers control of the call to prepayment SCP 84, in order to charge the call against the user's prepaid balance. As there are no IN services remaining to be applied to this call other than the prepaid service of SCP 84, the SSF logic of VSSF 20 may simply pass messages transparently between SCP 84 and MSC 28, or may even instruct SCP 84 to communicate directly with the MSC 28. The assigned dialog handler 58 in VSSF 20 may then close the session that was opened for the call, thus freeing resources to deal with other calls.

Although the embodiments and implementation scenarios described above relate to certain particular protocols and service types, the principles of the present invention may similarly be applied to provide other types and combinations of services, and in environments that use different communication protocols. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for providing a virtual service switching function, comprising:
receiving a first message from a switch in a telephone network indicative of initiation of a call, the first message comprising a service parameter that is applicable to the call;
responsively to the service parameter, invoking first and second service control points (SCPs) to provide respective first and second services in relation to the call; and
sending a second message to the switch, in response to the first message, instructing the switch to carry out the call using at least one of the first and second services.

2. The method according to claim 1, wherein receiving the first message comprises receiving an Intelligent Network Application Protocol (INAP) message from a service switching function of the switch.

3. The method according to claim 2, wherein the telephone network comprises a cellular communication network.

4. The method according to claim 1, and comprising receiving a third message sent from a packet network using a packet network protocol, and invoking at least one of the first and second SCPs responsively to the third message in order to provide one or more of the first and second services to a user of the packet network.

5. The method according to claim 4, wherein receiving the third message comprises receiving the third message in relation to a Voice over Internet Protocol (VoIP) call placed by the user over the packet network.

6. The method according to claim 4, wherein receiving the third message comprises receiving the third message in relation to a data service requested by the user of the packet network.

7. The method according to claim 4, wherein the first service comprises a prepayment service, and wherein the user has a prepaid account with the prepayment service, and wherein invoking the at least one of the first and second SCPs comprises causing the first SCP to charge the prepaid account in connection with use of the packet network.

8. The method according to claim 4, wherein receiving the third message comprises receiving a request to provide the one or more of the first and second services to the user at a specified telephone number via the telephone network.

9. The method according to claim 4, wherein receiving the third message comprises receiving at least one of a Session Initiation Protocol (SIP) message, a Transport Control Protocol (TCP) message, a Structured Query Language (SQL) message, and a Hypertext Transfer Protocol (HTTP) message.

10. The method according to claim 1, wherein the service parameter comprises a service key.

11. The method according to claim 10, wherein the service key is determined by at least one of an originating IN category key (OICK) corresponding to an originating telephone number of the call, and a terminating IN category key (TICK) corresponding to a terminating telephone number of the call, which are stored in a home location register (HLR) of the telephone network.

12. The method according to claim 11, and comprising defining, for use in the HLR, a first category key corresponding to the first service, a second category key corresponding to the second service, and a third category key corresponding to a combination of the first and second services.

13. The method according to claim 1, wherein invoking the first and second SCPs comprises sending an Intelligent Network Application Protocol (INAP) message to at least one of the first and second SCPs.

14. The method according to claim 13, wherein sending the INAP message comprises sending the INAP message from a virtual service switching function device while emulating a service switching function (SSF) of the switch, and wherein sending the second message to the switch comprises sending the second message from the virtual service switching function device while emulating a service control function of the at least one of the first and second SCPs.

15. The method according to claim 14, wherein sending the INAP message comprises sending the INAP message to the first SCP, wherein the second SCP is comprised in the virtual service switching function device.

16. The method according to claim 1, wherein the second SCP is comprised in a virtual service switching function device, and wherein invoking the first and second SCPs comprises sending a message from the VSSF device to the first SCP.

17. The method according to claim 1, wherein receiving the first message comprises receiving the first message at a virtual service switching function device while emulating a service control function of the at least one of the first and second SCPs, and wherein sending the second message comprises conveying an instruction from the virtual service switching function device to the at least one of the first and second SCPs to send the second message through the telephone network to the switch.

18. The method according to claim 17, wherein conveying the instruction comprises making a determination that the second service will not be required for the call, and conveying the instruction to the first SCP responsively to the determination.

19. The method according to claim 1, wherein invoking the first and second SCPs comprises sending a customized applications for mobile network enhanced logic (CAMEL) protocol message to at least one of the first and second SCPs.

20. The method according to claim 1, wherein invoking the first and second SCPs comprises communicating with the first and second SCPs using different, respective first and second communication protocols.

21. The method according to claim 1, wherein the first and second services are selected from a group of services consisting of a prepayment service, a personal number (PN) service, a call transfer service, a virtual private network service, a waking service, and a charge reversal service.

22. The method according to claim 21, wherein the first service is the PN service, and the second service is the call transfer service, and wherein sending the second message comprises instructing the switch, using the PN service, to cause first and second telephones to ring, whereupon a user accepts the call on the first telephone, and comprising receiving a signal from the first telephone to transfer the call to the second telephone, and instructing the switch, using the call transfer service, to transfer the call to the second telephone.

23. The method according to claim 21, wherein the first service is the charge reversal service, and the second service is the prepayment service, and wherein invoking the first and second SCPs comprises evaluating a terminating telephone number of the call against a predetermined list, using the first SCP, in order to determine whether to apply the charge reversal service, and if the terminating telephone number does not appear on the list, charging a prepaid account for the call using the second SCP.

24. Apparatus for providing a virtual service switching function, comprising:
a network interface, which is coupled to receive a first message from a switch in a telephone network indicative of initiation of a call, the first message comprising a service parameter that is applicable to the call;
a service interface, which is coupled to communicate with first and second service control points (SCPs), which are configured to provide respective first and second services; and
application logic, which is adapted, responsively to the service parameter, to invoke the first and second SCPs via the service interface responsively to the service key, and to send a second message to the switch via the network interface, in response to the first message, instructing the switch to carry out the call using at least one of the first and second services.

25. The apparatus according to claim 24, wherein the first message comprises an Intelligent Network Application Protocol (INAP) message sent from a service switching function of the switch.

26. The apparatus according to claim 25, wherein the telephone network comprises a cellular communication network.

27. The apparatus according to claim 24, wherein the network interface is further coupled to receive a third message sent from a packet network using a packet network protocol, and wherein the application logic is adapted to invoke at least one of the first and second SCPs responsively to the third message in order to provide one or more of the first and second services to a user of the packet network.

28. The apparatus according to claim 27, wherein the third message relates to a Voice over Internet Protocol (VoIP) call placed by the user over the packet network.

29. The apparatus according to claim 27, wherein the third message relates to a data service requested by the user of the packet network.

30. The apparatus according to claim 27, wherein the first service comprises a prepayment service, and wherein the user has a prepaid account with the prepayment service, and wherein the application logic is adapted to cause the first SCP to charge the prepaid account in connection with use of the packet network.

31. The apparatus according to claim 27, wherein the third message comprises a request to provide the one or more of the first and second services to the user at a specified telephone number via the telephone network.

32. The apparatus according to claim 27, wherein the third message comprises at least one of a Session Initiation Protocol (SIP) message, a Transport Control Protocol (TCP) message, a Structured Query Language (SQL) message, and a Hypertext Transfer Protocol (HTTP) message.

33. The apparatus according to claim 24, wherein the service parameter comprises a service key in a home location register (HLR) of the telephone network.

34. The apparatus according to claim 33, wherein the service key is determined by at least one of an originating IN category key (OICK) corresponding to an originating telephone number of the call, and a terminating IN category key (TICK) corresponding to a terminating telephone number of the call, which are stored in a home location register (HLR) of the telephone network.

35. The apparatus according to claim 34, wherein a first category key corresponding to the first service, a second category key corresponding to the second service, and a third category key corresponding to a combination of the first and second services are defined for use in the HLR.

36. The apparatus according to claim 24, wherein the application logic is adapted to invoke the first and second SCPs by sending an Intelligent Network Application Protocol (INAP) message to at least one of the first and second SCPs via the service interface.

37. The apparatus according to claim 36, wherein the application logic is adapted to emulate a service switching function (SSF) of the switch in sending the INAP message, and is further adapted to emulate a service control function of the at least one of the first and second SCPs in sending the second message to the switch.

38. The apparatus according to claim 37, wherein the INAP message is sent to the first SCP, and wherein the apparatus comprises the second SCP.

39. The apparatus according to claim 24, wherein the apparatus comprises the second SCP, and wherein the application logic is adapted to invoke the first SCP by sending a message to the first SCP via the service interface.

40. The apparatus according to claim 24, wherein the application logic is adapted to emulate a service control function of the at least one of the first and second SCPs in receiving the first message, and is further adapted to send an instruction via the service interface to the at least one of the first and second SCPs, instructing the at least one of the first and second SCPs to send the second message through the telephone network to the switch.

41. The apparatus according to claim 40, wherein the application logic is adapted to make a determination that the second service will not be required for the call, and to convey the instruction to the first SCP responsively to the determination.

42. The apparatus according to claim 24, wherein the application logic is adapted to invoke the first and second SCPs by sending a customized applications for mobile network enhanced logic (CAMEL) protocol message to at least one of the first and second SCPs via the service interface.

43. The apparatus according to claim 24, wherein the application logic is adapted to communicate with the first and second SCPs via the service interface using different, respective first and second communication protocols.

44. The apparatus according to claim 24, wherein the first and second services are selected from a group of services consisting of a prepayment service, a personal number (PN) service, a call transfer service, a virtual private network service, a waking service, and a charge reversal service.

45. The apparatus according to claim 44, wherein the first service is the PN service, and the second service is the call transfer service, and wherein the application logic is adapted to instruct the switch, using the PN service, to cause first and second telephones to ring, whereupon a user accepts the call on the first telephone, and is further adapted, upon receiving a signal from the first telephone to transfer the call to the second telephone, to instruct the switch, using the call transfer service, to transfer the call to the second telephone.

46. The apparatus according to claim 44, wherein the first service is the charge reversal service, and the second service is the prepayment service, and wherein the application logic is adapted to cause the first SCP to evaluate a terminating telephone number of the call against a predetermined list in order to determine whether to apply the charge reversal service, and if the terminating telephone number does not appear on the list, to cause the second SCP to charge a prepaid account for the call.
